(19) United States
(12) Patent Application Publication
(10) Pub. No.: US 2019/0320096 A1
(43) Pub. Date: Oct. 17, 2019

(54) CAMERA DEVICE AND ASSEMBLING METHOD FOR SAME

(71) Applicants: TRIPLE WIN TECHNOLOGY(SHENZHEN) CO.LTD., Shenzhen (CN); HON HAI PRECISION INDUSTRY CO., LTD., New Taipei (TW)

(72) Inventors: SHIN-WEN CHEN, New Taipei (TW); JING-WEI LI, Shenzhen (CN); SHENG-JIE DING, Shenzhen (CN); KUN LI, Shenzhen (CN)

(21) Appl. No.: 15/956,839

(22) Filed: Apr. 19, 2018

(30) Foreign Application Priority Data
Apr. 11, 2018 (CN) 201810322433.7

(51) Int. Cl. H04N 5/225; G02B 7/04; G03B 3/10

(52) U.S. Cl. CPC H04N 5/2253; G03B 3/10; G02B 7/04; H04N 5/2254

(57) ABSTRACT

A camera device allowing for easy and reliable mating to a circuit board includes a printed circuit board, an imaging sensor mounted on the printed circuit board, a supporting bracket mounted on the printed circuit board and surrounding the imaging sensor, and a lens module received in the supporting bracket. The printed circuit board includes a first portion and an extending portion connecting with the first portion, the first portion defines a first location and a second location. The first location surrounds the imaging sensor, and the second location is located outside of the first location and adjacent to the extending portion. The supporting bracket includes a main body and a fixing lug forming at side surface of the main body, bottom of the base and bottom of the fixing lug are coplanar.

### FIELD

The subject matter herein generally relates to camera device and an assembling method for a camera device.

### BACKGROUND

During testing of a camera device or when assembling of a camera device with the main board in electrical products, manual operation is usually needed. Manual removal will however often cause the lens holder to fall loose from the printed circuit board. Therefore, it is desirable to provide a camera device which can overcome the above-mentioned disadvantages.

### BRIEF DESCRIPTION OF THE DRAWINGS

Implementations of the present technology will now be described, by way of example only, with reference to the attached figures.

FIG. 1 is an isometric view of a camera device in accordance with one embodiment.

FIG. 2 is an exploded isometric view of the camera device in FIG. 1.

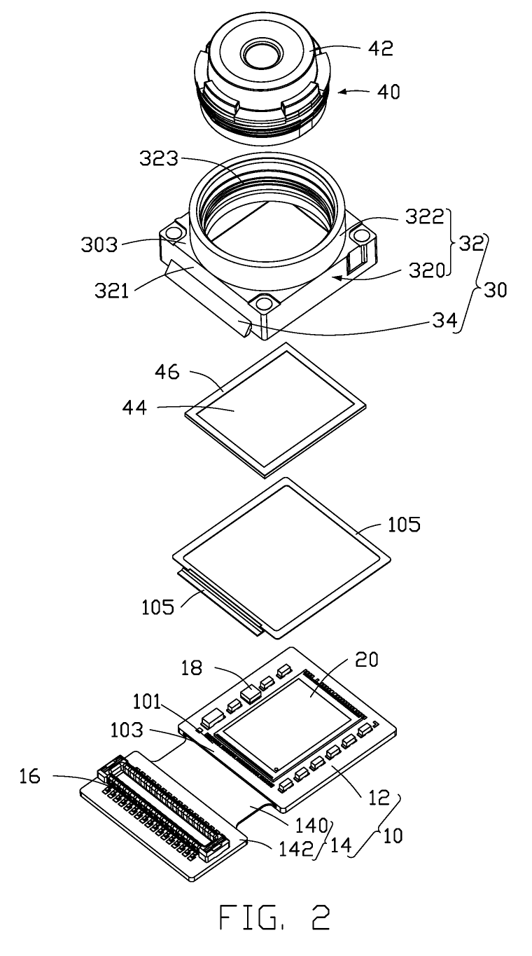

FIG. 3 is another exploded isometric view of the camera device in FIG. 1.

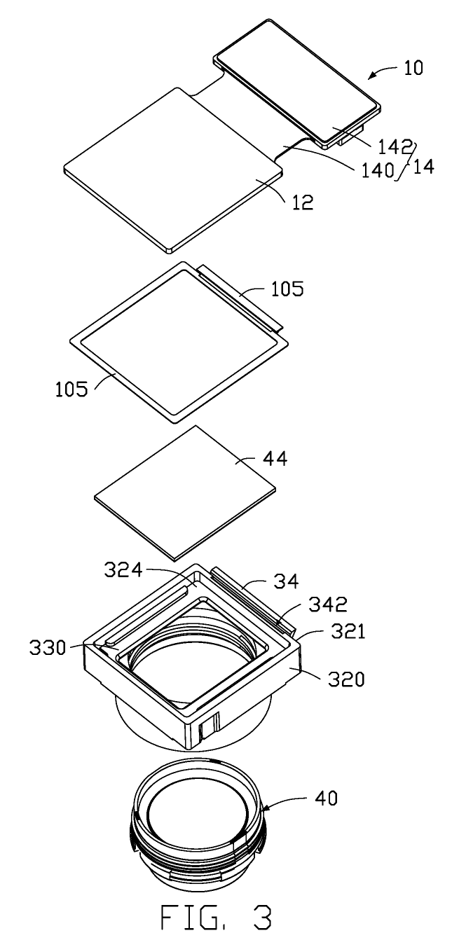

FIG. 4 is another isometric view of camera device in accordance with another embodiment.

FIG. 5 is an exploded isometric view of the camera device in FIG. 4.

FIG. 6 is another exploded isometric view of the camera device in FIG. 4.

FIG. 7 illustrates a flowchart of a method for assembling the camera device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more debytions from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

### EXAMPLE 1

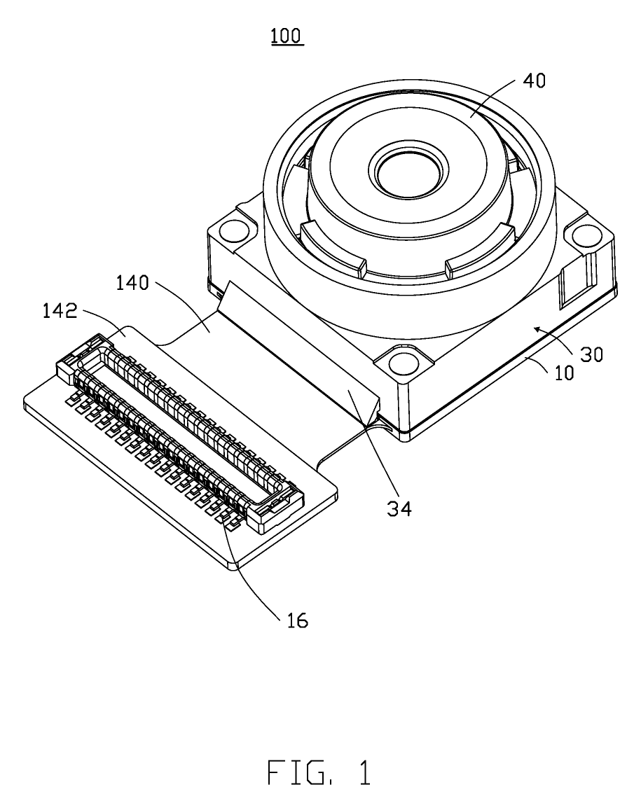

FIG. 1 illustrates a camera device 100 according to one embodiment. The camera device 100 can be a variable-focus or fixed-focus camera device. The camera device 100 includes a printed circuit board 10, an imaging sensor 20, a supporting bracket 30, and a lens module 40.

The printed circuit board 10 can be a flexible circuit board or a rigid-flexible board. The printed circuit board 10 includes a first portion 12 and an extending portion 14 connecting with the first portion 12. The first portion 12 is configured to bear the supporting bracket 30. The extending portion 14 includes a second portion 140 connecting with the first portion 12 and a third portion 142 connecting with the second portion 140. The second portion 140 may be a flexible circuit board. An external connector 16 is mounted to the third portion 142. The imaging sensor 20 is mounted on a central area of the first portion 12 and electrically connected to the first portion 12. The imaging sensor 20 is a CCD sensor or a CMOS sensor. The printed circuit board 10 further includes a plurality of passive components 18 mounted around the imaging sensor 20. The passive components 18 includes resistors, capacitors, and inductors.

The supporting bracket 30 in this embodiment is a lens holder 31. The lens holder 31 includes a main body 32 and a fixing lug 34 forming at side surface of the main body 32. The fixing lug 34 and the main body 32 are integrally formed in a mold. The main body 32 includes a base 320 and a receiving portion 322 extending from top surface 303 of the base 320. The base 320 can be substantially square and defines a receiving space 330 at bottom thereof. The base 320 is fixed on the first portion 12 and surrounds the imaging senor 20 and the passive components 18. The base 320 can alternatively be circular. The base 320 also includes a stepped portion 324 arranged on an inner surface thereof, and an optical filter 44 of a lens module 40 is fixed on the stepped portion 324 by a double-sided adhesive 46. The receiving portion 322 can be substantially circular and includes a receiving cavity 323 to receive the lens module 40.

The fixing lug 34 is formed one side surface 321 of the base 320. The fixing lug 34 is substantially a triangular prism. Bottom of the base 320 and bottom of the fixing lug 34 are coplanar. In other embodiment, the fixing lug 34 is can be trapezoidal, rectangular, or arc-shaped.

In this embodiment, a length of the fixing lug 34 substantially equals a width of the second portion 140. The width direction refers to a direction perpendicular to a direction along the first portion 12 extending to the third portion 142.

In this embodiment, the bottom of the fixing lug 34 defines a cutout 342. The cutout 342 is configured to accommodate adhesive.

The first portion 12 of the printed circuit board 10 defines a first location 101 and a second location 103. The first location 101 surrounds the imaging sensor 20, and the second location 103 is located outside of the first location 101 and adjacent to the extending portion 14. In the illustrated embodiment, the fixing lug 34 is fixed at a junction of the first portion 12 and the second portion 140. Adhesive 105 is applied to the first location 101 and the second location 103. The adhesive 105 is heat curable glue or UV glue.

The main body 32 is fixed on the printed circuit board 10 by the adhesive 105 on the first location 101, and the fixing lug 34 is fixed on the printed circuit board 10 by the adhesive 105 on the second location 103. Redundant adhesive 105 of the second location 103 fills into the cutout 342. Thereby, the fixing hug 34 and the adhesive 105 received in the cutout 342 are together configured to strengthen an adhesive force between the lens holder 31 and the printed circuit board, to avoid the lens holder 31 falling from the printed circuit board 10.

The lens module 40 is received in the receiving cavity 323. The lens module 40 can be a lens group or a single lens.

### EXAMPLE 2

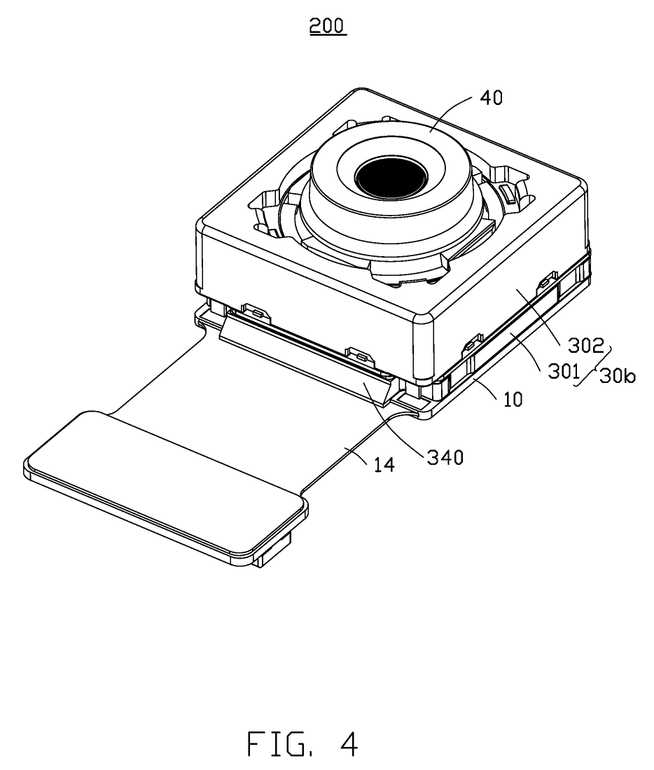

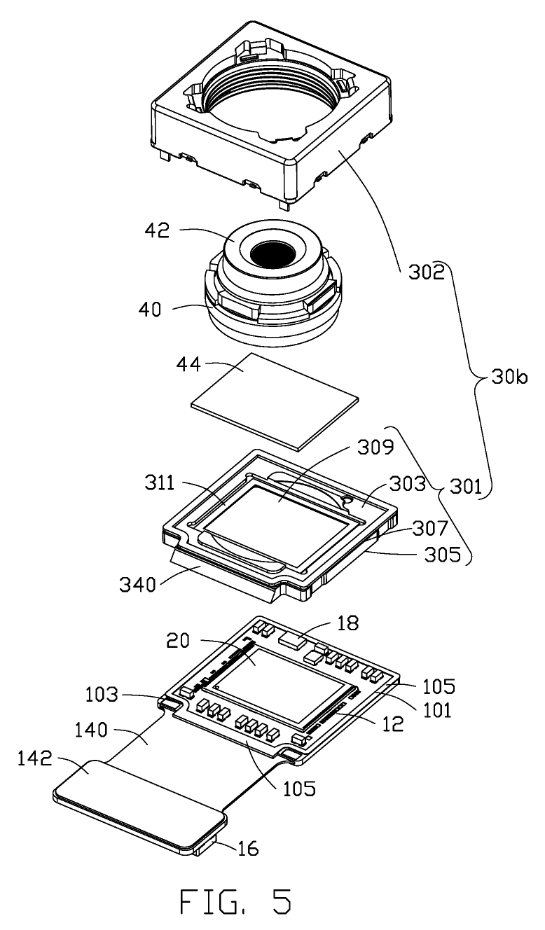

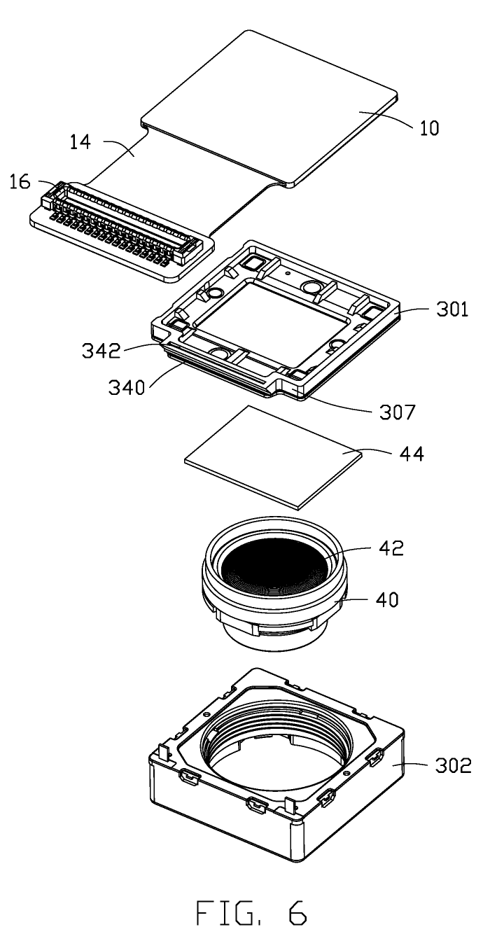

FIGS. 4-6 illustrate a camera device 200 according to another embodiment. The camera device 200 in FIG. 4 is similar to camera device 100 in FIG. 1. The difference between the camera device 200 and the camera device 100 in FIG. 1 is that the camera device 200 is a zoom camera device. The supporting bracket 30b includes a substrate pedestal 301 and a voice coil motor 302 mounted on the substrate pedestal 301 by adhesive, and the lens module 40 is received in the voice coil motor 302, and the voice coil motor 302 is configured to zoom the lens module 40.

The substrate pedestal 301 is fixed on the first portion 12 of the printed circuit board 10. The substrate pedestal 301 is substantially a square shape and includes a top surface 303 and a bottom surface 305 opposite to the top surface 303. The substrate pedestal 301 includes a light through hole 309 passing through the top surface 303 and the bottom surface 305, and a step portion 311 around the light through hole 309. The top surface 303 is recessed into the bottom surface 305 to form the step portion 311. The light through hole 309 is aligned to the imaging sensor 20. The optical filter 44 is fixed on the step portion 311.

The fixing lug 340 is formed on one side surface 307 of the substrate pedestal 301. The fixing lug 340 is substantially a triangular prism and also includes a cutout 344.

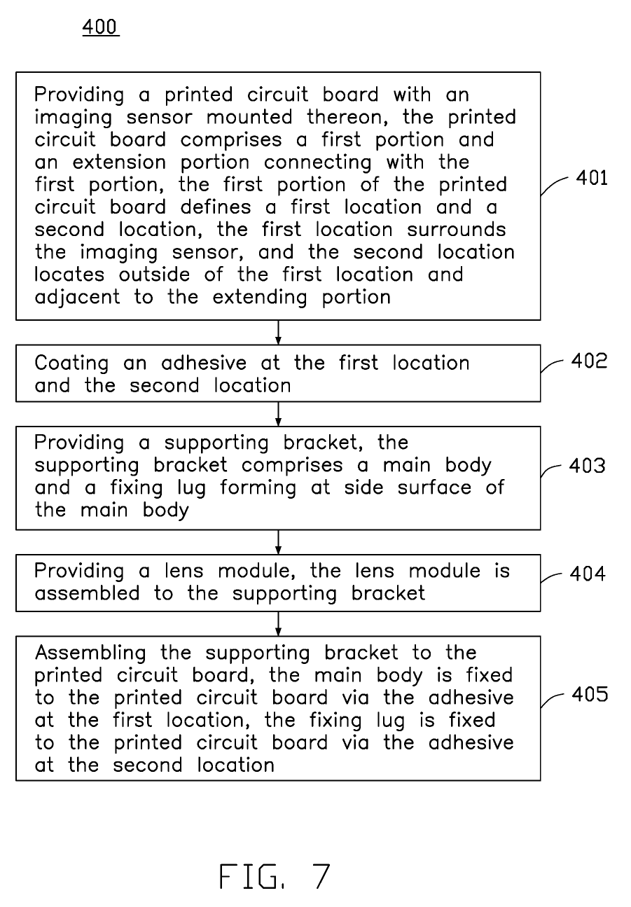

FIG. 7 illustrates a flowchart in accordance with one embodiment. The method 300 for assembling the camera device 100 shown in FIG. 1 is provided by way of example as there are a variety of ways to carry out the method. The method 400 can begin at block 401.

At block 401, with reference to FIG. 1, a printed circuit board 10 carrying an imaging sensor 20 is provided. The printed circuit board 10 includes a first portion 12 and an extending portion 14 connecting with the first portion 12. The printed circuit board 10 defines a first location 101 and a second location 103. The first location 101 surrounds the imaging sensor 20, and the second location 103 is located outside of the first location 101 and adjacent to the extending portion 14.

At block 402, an adhesive 105 is provided at the first location 101 and at the second location 103. The adhesive 105 is heat curable glue, UV glue or double-sided adhesive.

At block 403, a supporting bracket 30 is provided. The supporting bracket 30 in this illustrated embodiment is a lens holder, and the lens holder 31 includes a main body 32 and a fixing lug 34 at side surface of the main body 32. The fixing lug 34 and the main body 32 are integrally formed in a mold. Bottom of the base 320 and bottom of the fixing lug 34 are coplanar.

At block 404, a lens module 40 is provided. The lens module 40 is assembled with the supporting bracket 30, and the lens module 40 is fixed with the supporting bracket 30 using an adhesive.

At block 405, the supporting bracket 30 is assembled to the printed circuit board 10. The main body 32 is fixed to the printed circuit board 10 by the adhesive 105 at the first location 101, and the fixing lug 34 is fixed to the printed circuit board 10 by the adhesive 105 at the second location 103.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

1. A camera device comprising:
a printed circuit board, wherein the printed circuit board comprises a first portion and an extending portion connecting with the first portion, the first portion of the printed circuit board defines a first location and a second location, the extending portion comprises a second portion connecting with the first portion and a third portion connecting with the second portion;
an imaging sensor mounted on the printed circuit board, wherein the first location surrounds the imaging sensor, and the second location locates outside of the first location and adjacent to the extending portion;
a supporting bracket mounted on the printed circuit board and surrounding the imaging sensor; and
a lens module received in the supporting bracket, wherein the supporting bracket comprises a main body and a fixing lug forming at side surface of the main body, bottom of the base and bottom of the fixing lug are coplanar, the first location and the second location are arranged adhesive, the main body is fixed on the printed circuit board by the adhesive on the first location, the fixing lug is fixed on the printed circuit board by the adhesive on the second location,
wherein the fixing lug is substantially a triangular prism comprising a first surface, a second surface, and a third surface connected in that order, the first surface is fixed at a junction of the first portion and the second portion, the second surface is fixed to the main body.

2. The camera device of claim 1, wherein the fixing lug and the main body are integrally formed in a mold.

3. The camera device of claim 1, wherein the bottom of the fixing lug defines an accommodating space at a junction of the first surface and the second surface, the accommodating space is configured to accommodate adhesive.

4. The camera device of claim 1, wherein the fixing lug is substantially trapezoidal, rectangular or arcuately-shaped.

5. The camera device of claim 1, wherein the camera device is a fixed-focus camera device, and the supporting bracket is a lens holder, and the fixing lug is formed at one side surface of the lens holder.

6. The camera device of claim 5, wherein a length of the fixing lug substantially equals a width of the second portion, the width direction refers to a direction perpendicular to a direction along the first portion extending to the third portion.

7. The camera device of claim 6, wherein the main body comprises a base and a receiving portion extending from top surface of the base, the base defines a receiving space at bottom thereof, the receiving portion defines a receiving cavity to receive the lens module.

8. The camera device of claim 1, wherein the camera device is a zoom camera device, and the supporting bracket comprises a substrate pedestal and a voice coil motor mounted on the substrate pedestal, the lens module is received in the voice coil motor, and the fixing lug is formed at side surface of the substrate pedestal.

9. The camera device of claim 8, wherein the substrate pedestal is substantially a square shape and comprises a top surface and a bottom surface opposite to the top surface, the substrate pedestal comprises a light through hole passing through the top surface and the bottom surface, and the light through hole is aligned to the imaging sensor.

10. The camera device of claim 9, wherein the substrate pedestal further comprises a step portion around the light through hole; the lens module comprises an optical filter, and the optical filter is fixed on the step portion.

11. The camera device of claim 1, wherein the printed circuit board is a flexible circuit board or a rigid-flexible board.

12. The camera device of claim 11, wherein the second portion is a flexible circuit board, and the third portion is mounted with an external connector.

13. An assembling method for a camera device comprising:
providing a printed circuit board with an imaging sensor mounted thereon, wherein the printed circuit board comprises a first portion and an extending portion connecting with the first portion, the first portion of the printed circuit board defines a first location and a second location, the first location surrounds the imaging sensor, and the second location is located outside of the first location and adjacent to the extending portion, the extending portion comprises a second portion connecting with the first portion and a third portion connecting with the second portion;
coating an adhesive at the first location and the second location;
providing a supporting bracket, wherein the supporting bracket comprises a main body and a fixing lug forming at side surface of the main body;
providing a lens module, wherein the lens module is assembled to the supporting bracket and;
assembling the supporting bracket to the printed circuit board, wherein the main body is fixed to the printed circuit board by the adhesive at the first location, the fixing lug is fixed to the printed circuit board by the adhesive at the second location, wherein the fixing lug is substantially a triangular prism comprising a first surface, a second surface, and a third surface connected in that order, the first surface is fixed at a junction of the first portion and the second portion, the second surface is fixed to the main body.

14. The assembling method of claim 13, wherein the fixing lug and the main body are integrally formed in a mold.

15. The assembling method of claim 13, wherein the bottom of the fixing lug defines an accommodating space at a junction of the first surface and the second surface, accommodating space is configured to accommodate adhesive.

16. The assembling method of claim 13, wherein the fixing lug is substantially, trapezoidal, rectangular or arcuately-shaped.

17. The assembling method of claim 13, wherein the camera device is a fixed-focus camera device, and the supporting bracket is a lens holder, and the fixing lug is formed at one side surface of the lens holder.

18. The assembling method of claim 13, wherein the camera device is a zoom camera device, and the supporting bracket comprises a substrate pedestal and a voice coil motor mounted on the substrate pedestal, the lens module is received in the voice coil motor, and the fixing lug forming at side surface of the substrate pedestal.
